(19) United States
(12) Patent Application Publication
(10) Pub. No.: US 2017/0000159 A1
(43) Pub. Date: Jan. 5, 2017

(54) Edible adhesive sprinkle sideliner for cake decoration

(71) Applicant: Mary Zhu, Nashua, NH (US)

(72) Inventor: Mary Zhu, Nashua, NH (US)

(21) Appl. No.: 14/791,228

(22) Filed: Jul. 2, 2015

(51) Int. Cl. A23G 3/34

(52) U.S. Cl. CPC A23G 3/343; A23V 2002/00

(57) ABSTRACT

An edible adhesive sprinkle sideliner made with cake sprinkles encased between two thin layers of gelatin to be used to decorate the side surfaces of a buttercream frosting covered cake. The cake sprinkles can be arranged in the form of a single complete sheet or in the form of specific characters or designs. The final product can be packaged around a plastic spool for sale and distribution.

### CROSS REFERENCE TO RELATED APPLICATIONS

Not Applicable

### STATEMENT REGARDING FEDERALLY SPONSORED RESEARCH OR DEVELOPMENT

Net Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to an edible adhesive sideliner containing cake sprinkles for covering and decorating the side surfaces of a buttercream frosted cake.

In confectionery, while various topping materials are used for decorating a cake beautifully, the side surfaces of a cake usually lack design. The traditional technique of decorating or covering the side surfaces of a frosted cake is usually accomplished through one of three problematic methods.

One common method requires the individual who is decorating the cake to place a cooled cake on top of a cake board before covering the top and sides of the cake with frosting. Next, the individual picks up the cake hoard and carefully tilts it over a bowl of cake sprinkles. The individual then grabs a handful of the sprinkles from the bowl and presses it onto the frosted side surfaces of the cake. The individual repeats this step until there is an even coating of sprinkles over the side surfaces of the cake. Although this method may be effective for covering relatively small or lightweight cakes, this technique may be rather inconvenient due to the difficulty of balancing a large cake with one hand while scooping sprinkles with the other. Executing this method also creates a high risk of the cake getting damaged should the cake fall over when being balanced with one hand. Additionally, the process itself is quite messy due to the tendency of the sprinkles to spill and scatter all over while they are being grabbed and applied to the side surfaces of the cake.

An alternative common method requires the individual decorating the cake to spread cake sprinkles evenly onto a flat surface (such as a baking sheet). Then, the individual places a cooled cake on a cake board and frosts the sides of the cake. Next, the individual places the cake on its side atop the layer of sprinkles and rolls the cake until the frosted sides are completely covered with sprinkles. Although this method may be effective for covering relatively small, sturdy cakes, this process is rather difficult to administer when coating large or fragile cakes that crumble easily. Executing this method also creates a high risk of the cake falling apart or getting damaged if too much pressure is applied when the cake is rolled in the sprinkles. Additionally, the process is quite messy due to the tendency of the sprinkles to scatter all over while pouring out the sprinkles and rolling the frosted cake in the sprinkles.

The final alternative method requires the individual decorating the cake to spread cake sprinkles evenly onto a flat surface (such as a baking sheet). Then, the individual places a cooled cake on a cake board and frosts the sides of the cake. Next, the individual cuts out a rectangle of wax paper tailored to the height and circumference of the cake. The wax paper is then sprayed with cooking spray or coated with any type of cooking oil before being pressed flat against the sprinkles on its sprayed side. The individual then lifts the wax paper, which is now covered with sprinkles, and presses it against the side surfaces of the frosted cake. The individual finally peels off the wax paper so that the sprinkles now stick to the frosting on the sides of the cake. Although the cake is less likely to be damaged under this process in comparison to the two previously described methods, the cooking spray or cooking oil is often not sticky enough to ensure that the sprinkles completely cover the wax paper without falling off before being applied to the sides of the cake. Consequently, the side surfaces of the cake are also often not coated completely, forcing the individual to repeat the process coating the wax paper with oil or spray and dipping it into the sprinkles several times before producing a cake with an even layer of sprinkles covering the side surfaces. Not only is this method time-consuming, it is also messy due to the high chance that the sprinkles will fall off the wax paper and scatter all over during the process.

What is needed in the art is a safe, easy, edible, and mess-free means of securing and holding cake sprinkles on the sides of frosted cakes for decorating purposes.

### BRIEF SUMMARY OF THE INVENTION

Accordingly, one objective of the present invention is to describe an edible adhesive sideliner containing cake sprinkles for covering the frosted side surfaces of a cake for decorating purposes.

Further objectives and advantages of the invention will become apparent from a consideration of the drawings and ensuing description.

### BRIEF DESCRIPTION OF THE SEVERAL VIEWS OF THE DRAWING

FIG. 1 shows how a large, wide strip of edible adhesive sprinkle sideliner may be wrapped around the sides of a cylindrical frosted cake.

FIG. 1A is a perspective view of a cylindrical frosted cake showing a large, wide strip of edible adhesive sprinkle sideliner wrapped completely around the circumference of the cake.

FIG. 2 is an exploded view of a short strip of edible adhesive sprinkle sideliner containing a complete layer of cake sprinkles.

FIG. 3 is an exploded view of a short strip of edible adhesive sprinkle sideliner containing cake sprinkles arranged to horn specific characters and shapes.

FIG. 4 shows bow the edible adhesive sprinkle sideliner might be formed as a roll of material for sale and distribution.

FIG. 4A shows how the edible adhesive sprinkle sideliner might be packaged around a plastic spool for sale and distribution.

FIG. 5 shows a strip of edible adhesive sprinkle sideliner with sprinkles arranged to form specific characters and shapes for decorating and design purposes.

FIG. 5A shows the edible adhesive sprinkle sideliner featuring sprinkles arranged in specific characters and shapes as it appears when used on a frosted, cylindrical cake.

### DETAILED DESCRIPTION OF THE INVENTION

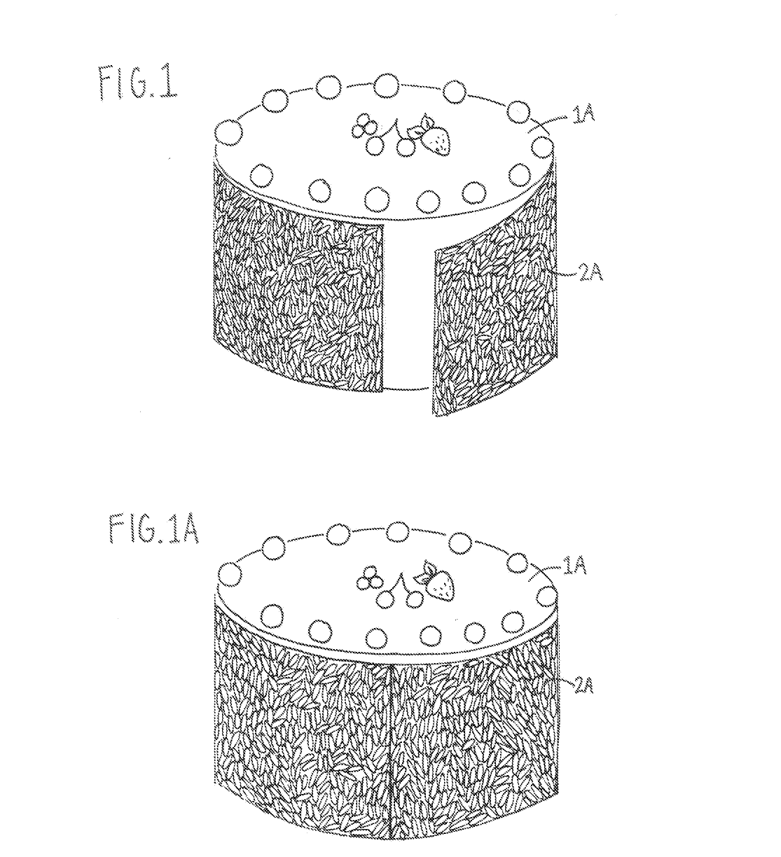

FIG. 1 is a perspective view of an edible adhesive sprinkle sideliner 2A being used on a frosted, cylindrical cake 1A. A large, wide strip of an edible adhesive sprinkle sideliner 2A is torn from its dispenser and is in the process o being wrapped around the sides of a cake frosted with buttercream frosting 1A. The edible adhesive sprinkle sideliner strip 2A is designed such that it will stick to the buttercream frosting covering the cake 1A.

FIG. 1A is a perspective view of all edible adhesive sprinkle sideliner 2A of FIG. 1 completely wrapped around the circumference of a frosted, cylindrical cake 1A also of FIG. 1. The edible adhesive sprinkle sideliner strip 2A adheres to the side surfaces of the frosted cake 1A.

Throughout the drawings and this specification, a variation of the number 2 shall be used as the reference designator when referring to any form of the edible adhesive sprinkle sideliner. A letter suffix shall be used after the number 2 to distinguish between the various embodiments of edible adhesive sprinkle sideliner. For example, the complete reference designator used to refer to the strip of edible adhesive sprinkle sideliner shown in FIG. 1 and FIG. 1A is “2A”, and the complete reference designator used to refer to the roll of edible adhesive sprinkle sideliner shown in FIG. 4 and FIG. 4A is “2D”. Both 2A and 2D refer to the present invention of edible adhesive sprinkle sideliner, with the letter suffix used to distinguish between different form factors of the edible adhesive sprinkle sideliner. This reference designator scheme (using the number “2” as a base for any bun of the edible adhesive sprinkle sideliner described herein) is used throughout the text of this specification.

Likewise, throughout the drawings and this specification a variation of the number 1 shall be used as the reference designator when referring to any form of buttercream frosted cake, a variation of the number 4 shall be used as the reference designator when referring to any form of gelatin, and a variation of the number 5 shall be used as the reference designator when referring to any form of cake sprinkles. A letter suffix shall be used after each of the numbers 1, 4, and 5 to distinguish between the various embodiments of buttercream frosted cake, gelatin, and cake sprinkles, respectively.

The edible adhesive sprinkle sideliner can be used on cakes of any size and of cylindrical or three-dimensional rectangular structure as a means of decorating the side surfaces of the frosted cake.

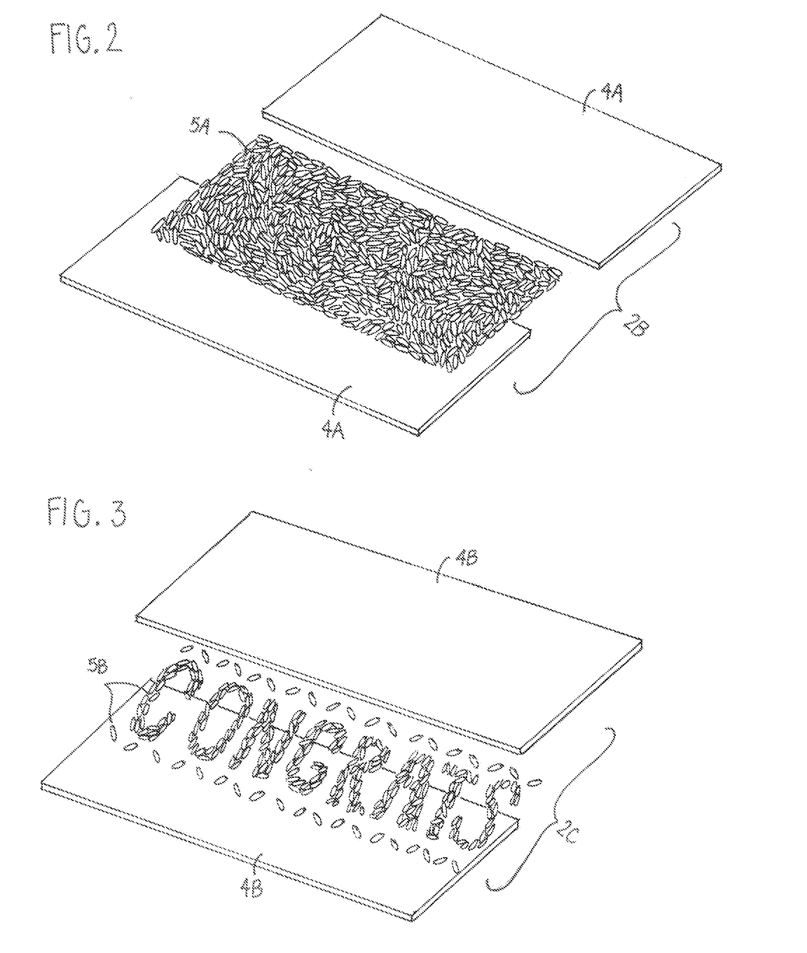

FIG. 2 is an exploded view of a short strip of edible adhesive sprinkle sideliner 2B containing a complete layer of cake sprinkles 5A. The layer of cake sprinkles 5A is sealed and suspended inside two thin layers of transparent gelatin 4A. The edible adhesive sprinkle sideliner 2B can be produced by first spreading cooled, semi-firm, unflavored, and transparent gelatin 4A thinly onto the flat surface of a shallow rectangular silicone mold. Then, a single, complete layer of sprinkles 5A is spread on top of the gelatin before a second thin layer of gelatin 4A is spread over the sprinkles. As the mixture is chilled until firm, the gelatin suspends and encases the sprinkles between the gelatin layers so that the product forms a thin, flat, and flexible sheet. Once firm, the sprinkle, and gelatin product can be removed from the rectangular silicone mold and wrapped around the sides of a frosted cake of respective dimensions, An example recipe for this edible adhesive sprinkle sideliner would one 0.25-ounce package of powdered colorless, unflavored gelatin, two cups of water, and 0.5 cup of cake sprinkles. This recipe may be adjusted depending on the desired size of the edible adhesive sprinkle product.

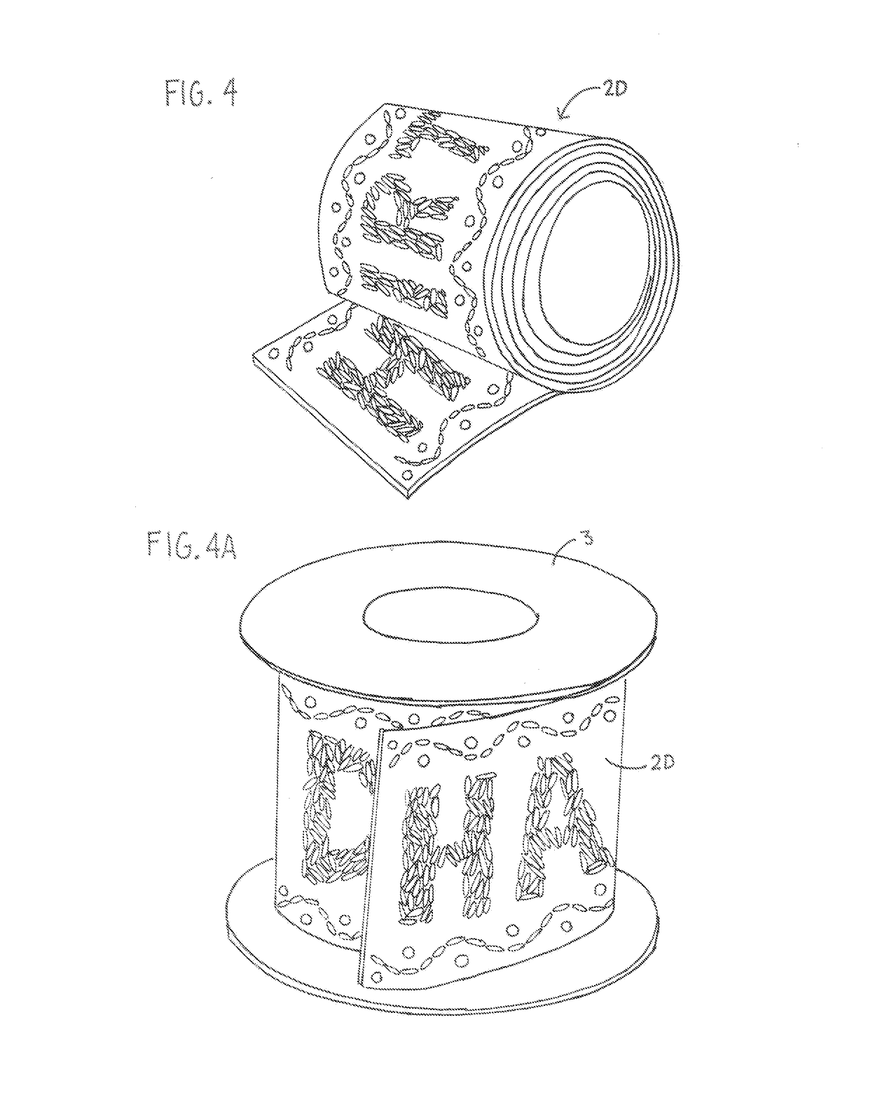

FIG. 3 is an exploded view of a short strip of edible adhesive sprinkle sideliner 2C containing cake sprinkles 5B arranged to form specific characters and shapes. The word “CONGRATS” and the surrounding sprinkles 5B are stamped inside two sheets of chilled, unflavored gelatin 4B to form a strip of edible adhesive sprinkle sideliner 2C. The edible adhesive sprinkle sideliner 2C can be produced by spreading cool, semi-firm unflavored gelatin 4B thinly onto the flat surface of a shallow, rectangular silicone mold. Then, sprinkles 5B may be pressed onto the semi-firm surface of the gelatin in the form of specific characters and shapes. A second thin layer of cooled, semi-firm gelatin 4B would be spread over the stamped gelatin to seal the sprinkles inside the two gelatin layers. As the product chills, the sprinkles are suspended and stuck between the two layers of gelatin in the form of specific characters and shapes. Once firm, the sprinkle and gelatin product can be removed from the rectangular silicone mold and wrapped around the sides of a frosted cake of respective dimensions. An example recipe for the edible adhesive sprinkle sideliner would be one 0.25-ounce package of powdered colorless, unflavored gelatin, two cups of water and 0.25 cup of cake sprinkles. This recipe may be adjusted depending on the desired size of the edible adhesive sprinkle product and the amount of sprinkles needed to form the desired characters and designs.

It may be desirable to create a version of the edible adhesive sprinkle sideliner that is not tacky until it is ready to be wrapped around a frosted cake. Edible adhesive sprinkle sideliners created using a dehydrating process can be made such that it is relatively inadhesive until it has been moistened. An inadhesive version of the edible adhesive sprinkle sideliner might be more convenient for packaging, storage purposes or for use in commercial operations. The edible adhesive sprinkle sideliner could then be “activated” so that it becomes adhesive by wiping it with a moist napkin or cloth or spraying it with water so that it could be applied to the sides of a frosted cake.

The creation of the edible adhesive sprinkle sideliner can be automated with machines that can be used to produce rolls or sheets of the gelatin and cake sprinkle material in large quantities for commercial distribution. The sprinkles may be spread or arranged onto the gelatin with any appropriate manufacturing process. The relevant form factors and embodiments of the edible adhesive sprinkle sideliner are described in the following paragraphs.

FIG. 4 shows an embodiment of a commercially-viable form of the edible adhesive sprinkle sideliner product. A single long strip of edible adhesive sprinkle sideliner tailored to specific dimensions of height, length, and width that would be mentioned on the label of the finished product is packaged and sold as a roll of edible adhesive sprinkle sideliner 2D. The roll of edible adhesive sprinkle sideliner 2D may be sold in plastic spools.

FIG. 4A shows one embodiment of such a plastic spool in which the roll of edible adhesive sprinkle sideliner 2B might be sold. The roll of edible adhesive sprinkle sideline, 2B is wrapped around a plastic spool 3.

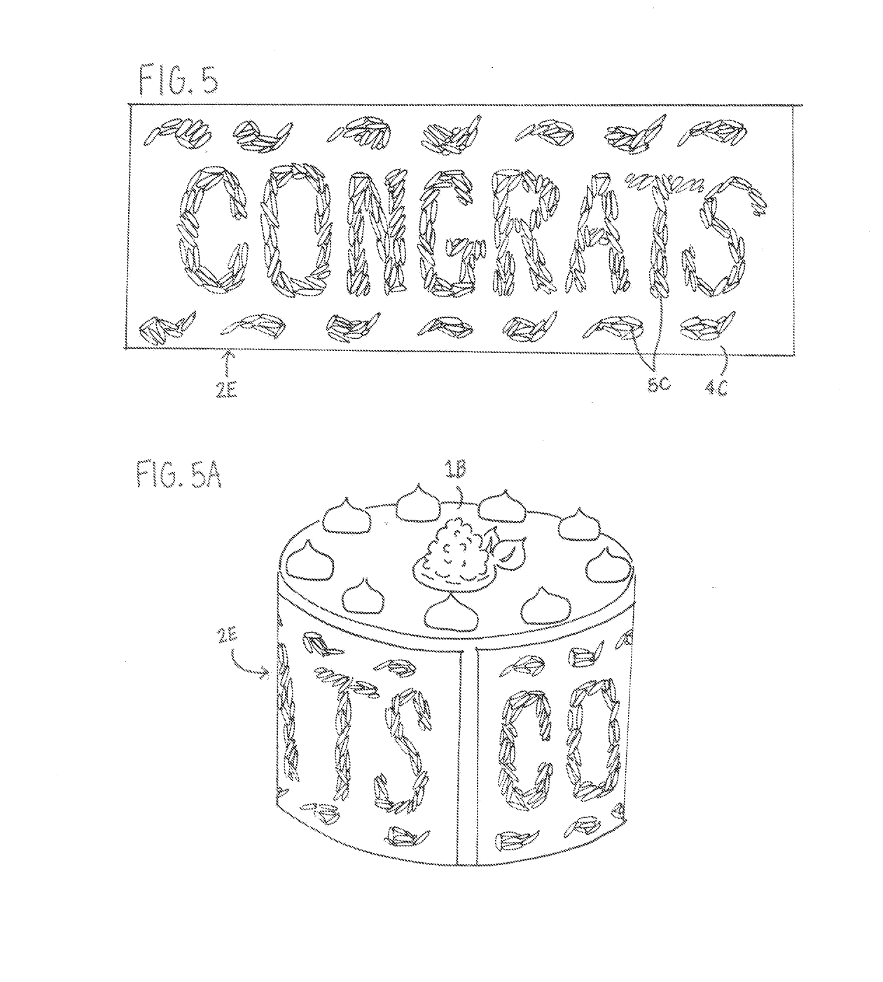

FIG. 5 shows a strip of edible adhesive sprinkle sideliner with sprinkles arranged to form specific characters and designs. The word “CONGRATS.” and the swirl designs 5C are stamped inside two thin sheets of chilled, unflavored gelatin 4C to form a strip of edible adhesive sprinkle sideliner 2E. Methods of manufacturing versions of the edible adhesive sprinkle sideliner with the sprinkles formed into specific characters and designs have been previously described in this specification.

FIG. 5A shows the edible adhesive sprinkle sideliner 2E of FIG. 5 as it appears when used on a cylindrical frosted cake la The edible adhesive sprinkle sideliner 2E serves the same decorative function as the strip of edible adhesive sprinkle sideliner 2A in FIG. 1 and FIG. 1A, and only the arrangement of the sprinkles is different. The edible adhesive sprinkle sideliner 2E will stick to the buttercream frosting coating the cylindrical cake 1B.

1. An edible adhesive sprinkle sideliner made with cake sprinkles sealed inside two thin layers of gelatin which is applied to the side surfaces of a buttercream frosted cake for decoration purposes.

2. The edible adhesive sprinkle sideliner of claim 1 wherein the cake sprinkles encased between the two layers of gelatin is selected from the group nonpareils, cylinder sprinkles, dragée, and shaped sprinkles.

3. The edible adhesive sprinkle sideliner of claim 2 wherein the cake sprinkles encased between the two layers of gelatin are spread in a complete, fiat layer with minimal space between the sprinkles.

4. The edible adhesive sprinkle sideliner of claim 2 wherein the cake sprinkles encased between the two layers of gelatin are arranged in specific characters or designs.

5. The edible adhesive sprinkle sideliner of claim 2 wherein the edible adhesive sprinkle sideliner is applied by wrapping it exactly once around the side surfaces of a buttercream frosted cake.

6. The edible adhesive sprinkle sideliner of claim 5 Wherein the form factor of the edible adhesive sprinkle sideliner is a rectangular sheet of material.

7. The edible adhesive sprinkle sideliner of claim 6 wherein the form of the edible adhesive sprinkle sideliner is a roll of edible material.

8. The edible adhesive sprinkle sideliner of claim 7 wherein the roll of edible material is packaged around a plastic spool.
